(19) United States
(12) Patent Application Publication
(10) Pub. No.: US 2025/0042779 A1
(43) Pub. Date: Feb. 6, 2025

(54) Method and System for Iron Distribution in Marine Environment

(71) Applicant: Keith Sasaki, San Diego, CA (US)

(72) Inventor: Keith Sasaki, San Diego, CA (US)

(21) Appl. No.: 18/781,004

(22) Filed: Jul. 23, 2024

Related U.S. Application Data
(60) Provisional application No. 63/529,812, filed on Jul. 31, 2023.

(51) Int. Cl. C02F 1/461; B01D 53/14; C02F 103/08

(52) U.S. Cl. CPC C02F 1/46176; C02F 1/46109; B01D 53/1475; B01D 53/1493; B01D 2252/1035; B01D 2252/602; C02F 2001/46138; C02F 2103/08

(57) ABSTRACT

A galvanic system for iron dissolution in an aquatic environment comprises an anode structure including one or more pieces of iron or iron alloy; a cathode structure including a buoyant component and a first metal layer coated on the buoyant component, the first metal layer having a higher potential than the one or more pieces of iron or iron alloy; one or more wires electrically connect the first metal layer of the cathode structure to the one or more pieces of iron or iron alloy of the anode structure, wherein the anode structure and a portion of the first metal layer are operably submerged in the aquatic environment. The anode structure may further include a rack holder having multiple slots for separately holding the one or more pieces of iron or iron alloy. The cathode structure may further include a noble metal layer coated on the first metal layer.

### CROSS-REFERENCE TO RELATED APPLICATIONS

The present application claims priority to provisional application No. 63/529,812, filed on Jul. 31, 2023, the content of which is incorporated herein by reference in its entirety.

### BACKGROUND OF THE INVENTION

The present invention relates to carbon sequestration from the atmosphere by stimulating the growth of phytoplankton, and more particularly, to a method and system for iron fertilization in a marine aquatic environment.

Iron fertilization of the ocean is a possible means of carbon sequestration via a multiplier effect between the amount of carbon uptake and the amount of iron that is released, however, the efficiency of long-term sequestration in such a situation is not 100% to say the least (See Aumont et al., Globalizing results from ocean in situ iron fertilization studies, Global Biogeochemical Cycles, Vol. 20, GB2017 (2006); W. Cornwell, To draw down carbon, ocean fertilization gets another look, Science, Vol. 374 (2021)). In its best-case use, the introduction of iron to areas of the ocean where iron depletion is the only limit to phytoplankton growth, the bottom of the food chain is stimulated, which by itself is a possible boon to the carbon content of the local ecosystem. Note that in such a case, long-term release of iron is required for on-going capture. In a less desirable outcome, excessive iron introduction leads to algal growth and a subsequent algal bloom. What type of growth is stimulated is likely contingent on the local flora, which can depend on the area and depth of the release (See Angelova et al., Microbial Composition and Variability of Natural Marine Planktonic and Biofouling Communities From the Bay of Bengal, Frontiers in Microbiology, Vol. 10 (2019)), although even in the less desirable case, if gradual release of the iron is suspended, it might lead to a quick reversal of the growth (See Barak-Gavish et al., Bacterial lifestyle switch in response to algal metabolites, ELife (2013)). Carbon sequestration will not be uniform at all spots in the ocean, but will likely depend on things such as: location, circulation, depth of iron ion introduction, rate and method of iron ion introduction (batch or semi-batch vs continuous), and the aforementioned local flora.

Information relevant to attempts to utilize iron fertilization of the ocean to increase the local carbon content of the area of interest for specific ends, either local seafood promotion or carbon sequestration or both, can be found in U.S. Pat. Nos. 5,967,087, 6,200,530, 6,408,792, 6,440,367, 8,825,241, and 9,802,681 and U.S. Patent Application Publication Nos. 2003/0012691, 2011/0282773, 2017/0360065, and 2018/0217119. However, each one of these references uses a physical delivery method of some sort to deliver an iron salt or chelate to the euphotic zone in the ocean, which limits the duration of the fertilizing process.

U.S. Pat. No. 8,722,390 to Aramayo et al. (hereinafter “Aramayo”) utilizes electrochemical dissolution as the method for producing iron ions. The first embodiment of Aramayo describes a method of electrically connecting a more noble metal to a solid iron source to produce iron ions in the euphotic zone, but the reaction at the cathode is described as the reduction of copper ions to copper metal (likened to the Baghdad battery). The actual cathodic reaction that may likely occur will, in fact, increase the local pH. The cathode/anode area relationship, local pH change, and the actual cathodic reaction are not considered. The second embodiment of Aramayo is described where an external power source controls the electrode potential of the entire frame to that where the Pourbaix diagram indicates stable iron ions for the conditions measured (pH, temp, and dissolved oxygen are stated as being measured by the control system). The issue with using a Pourbaix diagram in this method is the fact that at the pH of the working conditions in the ocean, an important issue with iron dissolution rate is likely to be mass-transfer. For both embodiments presented, one needs to make sure that the iron concentrations do not exceed the concentrations where iron precipitation will occur. The region of stability of the iron ions is dependent upon the ion activities for the Pourbaix region of stability demarcation between the metal ion and metal hydroxide.

For the foregoing reasons, there is a need for a system that can reliably and continuously release iron ions into the surrounding aquatic environment via galvanic reactions without the need for a control system.

### SUMMARY OF THE INVENTION

The present invention is directed to a system that satisfies this need. A galvanic system, which is capable of autonomous, continuous, and long-term generation of iron ions in an aquatic environment without the need for a control system of any type, comprises one or more pieces of iron or iron alloy; a cathode structure including a buoyant component and a first metal layer coated on the buoyant component, the first metal layer having a higher potential than the one or more pieces of iron or iron alloy; one or more wires electrically connect the first metal layer of the cathode structure to the one or more pieces of iron or iron alloy of the anode structure, wherein the anode structure and a portion of the first metal layer are operably submerged in the aquatic environment. The anode structure may further include a rack holder having multiple slots for separately holding the one or more pieces of iron or iron alloy. The cathode structure may further include a noble metal layer coated on the first metal layer.

### BRIEF DESCRIPTION OF DRAWINGS

These and other features, aspects, and advantages of the present invention will become better understood with regard to the following description, appended claims, and accompanying drawings where:

FIG. 1 is a Pourbaix diagram for the iron/water system in a wet/humid setting at T=25° C. where hydroxides are the stable solid components;

FIG. 2 shows the cathodic and anodic potentiodynamic scans for various metals and alloys in an aerated 3% NaCl solution;

FIG. 3 is a plot showing relationship between ocean pH and ocean depth in the equatorial Pacific;

FIG. 4 is a plot showing effect of nickel alloy content on the anodic behavior of NiFe alloys in 1 M sulfuric acid at T=25° C.: Curve 1, iron; Curve 2, Fe-10Ni; Curve 3, Fe-36Ni; Curve 4, nickel;

FIG. 5 illustrates a galvanic system for iron dissolution in an aquatic environment in accordance with an embodiment of the present invention;

FIG. 6 is a perspective view illustrating a cathode structure in accordance with an embodiment of the present invention; and

FIG. 7 is a perspective view illustrating an anode structure in accordance with an embodiment of the present invention.

For purposes of clarity and brevity, like elements and components will bear the same designations and numbering throughout the Figures, which are not necessarily drawn to scale.

### DETAILED DESCRIPTION OF THE INVENTION

In the Summary above and in the Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously, except where the context excludes that possibility, and the method can include one or more other steps which are carried out before any of the defined steps, between two of the defined steps, or after all the defined steps, except where the context excludes that possibility.

The term “at least” followed by a number is used herein to denote the start of a range beginning with that number, which may be a range having an upper limit or no upper limit, depending on the variable being defined. For example, “at least 1” means 1 or more than 1. The term “at most” followed by a number is used herein to denote the end of a range ending with that number, which may be a range having 1 or 0 as its lower limit, or a range having no lower limit, depending upon the variable being defined. For example, “at most 4” means 4 or less than 4, and “at most 40%” means 40% or less than 40%. When, in this specification, a range is given as “a first number to a second number” or “a first number-a second number,” this means a range whose lower limit is the first number and whose upper limit is the second number. For example, “25 to 100 nm” means a range whose lower limit is 25 nm and whose upper limit is 100 nm.

Directional terms, such as “front,” “back,” “top,” “bottom,” and the like, may be used with reference to the orientation of the illustrated figure. Spatially relative terms, such as “beneath,” “below,” “under,” “lower,” “upper,” “above,” etc., may be used herein to describe one element's relationship to another element(s) as illustrated in the figure. Since articles and elements can be positioned in a number of different orientations, these terms are intended for illustration purposes and in no way limit the invention, except where the context excludes that possibility.

Unless otherwise defined, all terms (both technical and scientific) used herein have the same meaning as commonly understood by one having ordinary skill in the art to which this invention belongs and to the processes that can be used to produce such. It is further understood that terms, such as those defined in commonly used dictionaries should be interpreted as having a meaning that is consistent with their meaning in the context of the relevant art and the present disclosure and will not be interpreted in an idealized or overly formal sense unless expressly so defined herein

Where reference is made herein to a material AB composed of element A and element B, the material AB can be an alloy, a compound, or a combination thereof, except where the context excludes that possibility.

The driving force for iron dissolution can be the galvanic coupling of a more noble metal or alloy (cathode) to a less noble metal or alloy which contains iron (anode). Generating continuous iron dissolution in an aquatic marine environment at a significant rate, however, is not as straightforward as simply electrically connecting a less noble metal or alloy containing iron to a more noble metal or alloy. Note that the use of a control system for the dissolution is likely not required if judicious choices for the materials and system configuration are chosen and optimized.

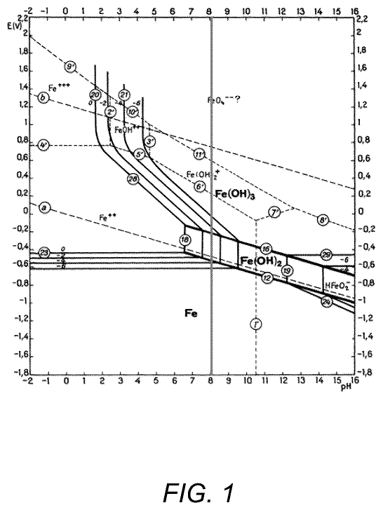

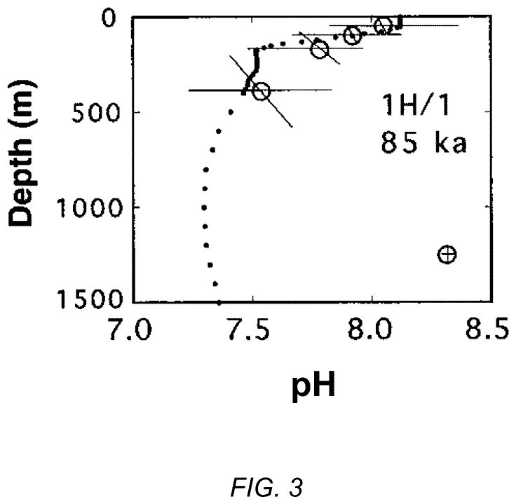

One of the primary issues that the marine environment can present is based upon the pH of the electrolyte (ocean water). The average pH of the ocean surface is just above 8.0 (Palmer et al., Reconstructing Past Ocean pH-Depth Profiles, Science, Vol. 282 (1998), hereinafter “Palmer”), which limits the stable region that iron dissolution can occur. This can be seen graphically in FIG. 1, which shows the Pourbaix diagram for the iron/water system in a wet/humid setting (where the hydroxides are the stable solid components), reproduced from the book by M. Pourbaix, “Atlas of Electrochemical Equilibria in Aqueous Solutions,” NACE, Houston (1974). The Pourbaix diagrams are graphical representations of the stable chemical species at various pH/potential regions after making an ab initio assumption of the possible species present for the metal of interest. For the iron hydroxides as the solid components of interest, a stable pH/potential region for the Fe2⁺ ions does exist, but requires that ion activity (concentration) does not get too high. Note that the iron dissolution, itself, can occur at a controlled water depth. This can be important since the pH of the ocean decreases at greater depth before stabilizing around 500 meters, as seen in FIG. 3 (reproduced from Palmer). For long-term dissolution of the anode, the dissolution current density should be balanced by the design of the anodic structure so the mass-transfer of the iron ions does not cause local concentrations to lead to the appearance of non-soluble species. Note that this requirement will need to address the current distribution at the anode, which will not be uniform over the entire anodic surface and will likely be a function of the depth.

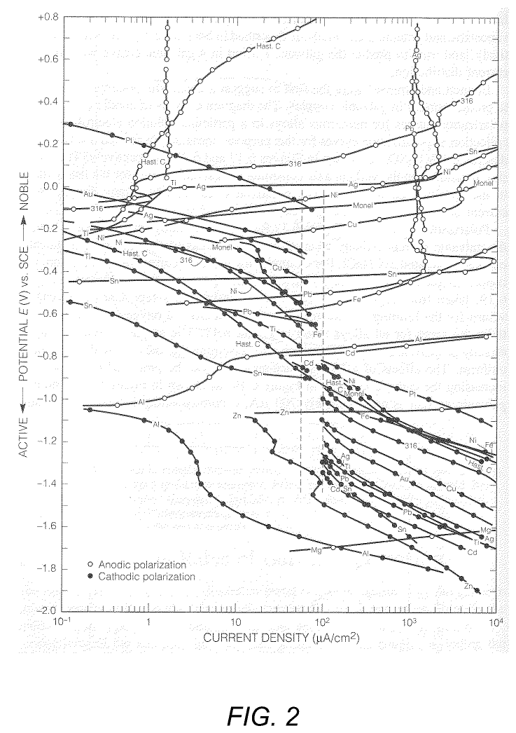

Another issue is due to the specific chemical reaction that must occur on the cathode for anodic iron dissolution to occur. A galvanic couple must have an equilibrium between the electrons generated when metal ions are dissolved and the electrons consumed by the counter reaction that occurs on the cathode (more noble metal or alloy). As noted above, the pH of the aqueous system of interest is in the range of 8.0, which will obviously not have adsorbed H⁺ ions in abundance. The relevant reaction in this case is thus: O₂+2H₂O+4e⁻→4OH⁻, where dissolved oxygen content and total cathodic area will determine the total reaction rate. This can be seen graphically in FIG. 2, which shows the cathodic and anodic potentiodynamic scans for various metals and alloys in an aerated 3% NaCl solution, reproduced from the book by D. Jones, “Principles and Prevention of Corrosion,” Macmillan, New York (1992). The 3% NaCl solution can be considered as a simple proxy for an aquatic marine solution. Effectively, the adsorption and surface diffusion of the dissolved oxygen from the aqueous solution to the cathode (more noble metal or alloy) will be rate determining for the iron dissolution. With continued reference to FIG. 2, the reaction rate and potential are at the intersection of the anodic and cathodic curves (which in the actual case are adjusted for the actual area of both the anode and cathode); for the cathodic curves, note the discontinuity at around 50-100 μA/cm² (demonstrated graphically by the dashed vertical lines), which is effectively the point where the concentration of the dissolved oxygen content begins to constrain the cathodic reaction rate current density. Besides an increase in cathodic area, another possible way to increase the local reaction rate would be a method of increasing the adsorbed oxygen on the cathode surface. A structure that is only partially submerged will take advantage of the waterline, which can influence the local reaction rate due to increased oxygen availability at the first few millimeters of the surface region.

Gradual introduction of the iron ions that can be introduced via galvanic coupling has a benefit in that it can be stopped at any time by breaking the electrical connection if the growing flora is problematic. A downside of this methodology in a marine aquatic environment is the possibility of fouling that blocks the surface areas of the cathode and/or anode. The addition of lead or copper to the near surface regions can mitigate fouling, as can specific chemical coatings. In the case of an immersed structure, a chemical coating is counterproductive since one desires the anode, for instance, to dissolve. The dissolving anode may be useful to mitigation in that an alloy of iron containing enough copper may lead to the release of enough copper ions to achieve anti-fouling. Note that for long-term usefulness, both metals will ideally dissolve simultaneously. Note that the same effect may be possible if a holder for the anodic material is used and is further comprised of a material whose nobility is between the chosen cathode surface material and the iron or iron alloy. In this case, the corrosion potential may be slightly increased with a slight change in the kinetics for the iron or iron alloy and a small amount of dissolution possible for the holder material—if the holder material contains copper (e.g., aluminum bronze, bronze, and brass are some possibilities), the same type of anti-fouling benefit may be possible. For the cathode, a bi-layer structure with a copper substrate or underlayer and a thin overcoat of the more noble metal or alloy (which may have porosity to the undercoat) has the possibility of some protection.

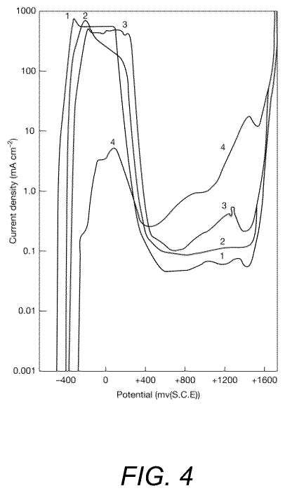

The balanced intersection of the cathodic and anodic curves occurs at a specific potential and rate. As noted above, the Pourbaix diagram dictates the limits of the iron concentrations at which continual dissolution can occur without the possibility of hydroxide formation at this potential. Also as stated, the pH near the anode can be changed to some extent via the depth of the anodic structure. Some control of the potential is also possible via the use an iron alloy with an added amount of an additional metal (or metals), which will change the anodic polarization curve and thus the intersection potential—as seen for NiFe alloys in FIG. 4 reproduced from the Ph.D. dissertation of R. L. Beauchamp, Ohio State University (1966). For long-term usefulness, both metals need to dissolve simultaneously, which will happen for FeZn alloys, for instance (Barbosa et al., Fe—Zn film stripping voltammetry: Theoretical and experimental study, Electrochimica Acta, Vol. 50, 24 (2005)).

Since the cathodic structure has some kinetic advantages at the waterline, it is preferable to have the density of the components allow for surface placement without undue support structures. Thus, for example, a thin coating of metal over a lower density material would be ideal—this also opens the possibility of using a very thin layer of the higher cost metal or alloy for the cathode surface area without overall cost increasing exorbitantly as the cathodic surface area is increased. For this particular use, the term “lower density” would be defined relative to the density of an aquatic environment, such as marine aqueous solution.

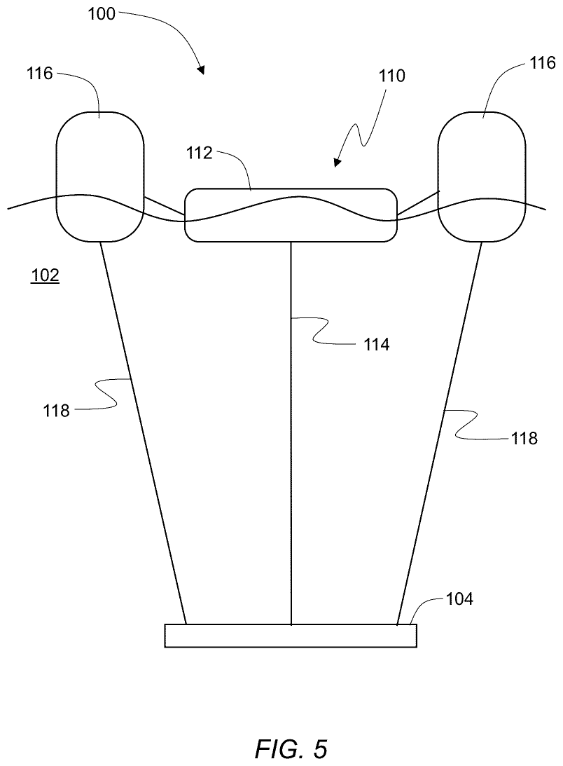

FIG. 5 illustrates a galvanic system for continuous iron dissolution in an aquatic environment in accordance with an embodiment of the present invention. The galvanic system 100 may be operably placed in an aquatic environment 102 and comprises an anode structure 104 that includes one or more pieces of iron or iron alloy, such as but not limited to an iron-rich alloy and/or an iron-zinc (FeZn) alloy; a cathode structure 110 including a buoyant component 112 and a first metal layer coated on the buoyant component, the first metal layer having a higher potential than the one or more pieces of iron or iron alloy; and one or more wires 114 electrically connect the first metal layer of the cathode structure 110 to the one or more pieces of iron or iron alloy of the anode structure 104. The anode structure 104 and a portion of the first metal layer on the buoyant component 112 are operably submerged in the aquatic environment 102. In the galvanic system 100, the cathodic half reaction (i.e., oxygen reduction) mainly occurs at the submerged surface of the cathode structure 110 and the anodic half reaction (i.e., dissolution of iron) mainly occur on the surface of the one or more pieces of iron or iron alloy of the anode structure 104. The aquatic environment 102 may be a body of saltwater (e.g., ocean) or any body of water with sufficient conductivity to facilitate a working electrochemical cell. The cathode structure 110 operably floats on the surface of the aquatic environment 102 and may have a center of gravity below the water line to help maintain stability.

The galvanic system 100 may further include one or more buoy structures 116 that suspend the anode structure 104 in the aquatic environment 102 by one or more lines or cables 118. The buoy structures 116, along with the cathode structure 110, may float on the surface of the aquatic environment 102 to provide additional buoyant force to suspend the anode structure 104 at a depth. The buoy structures 116 may be tethered to the cathode structure 110. Note that although the buoy structures 116 are illustrated, any floating vessel or structure at the water line can be utilized instead. Alternatively, the anode structure 104 may be suspended by a fixed structure (not shown), such as but not limited to an oil rig.

As noted above, the galvanic reactions for producing iron ions may be limited by the oxygen reduction reaction, which depends on the dissolved oxygen content and the area of the cathode structure 110 submerged in the aquatic environment 102. Since the concentration of dissolved oxygen in the aquatic environment 102 is highest near its surface, the floating cathode structure 110 with large surface area exposed to the waterline to increase the adsorbed oxygen content may accelerate the production of iron ions through the galvanic reactions.

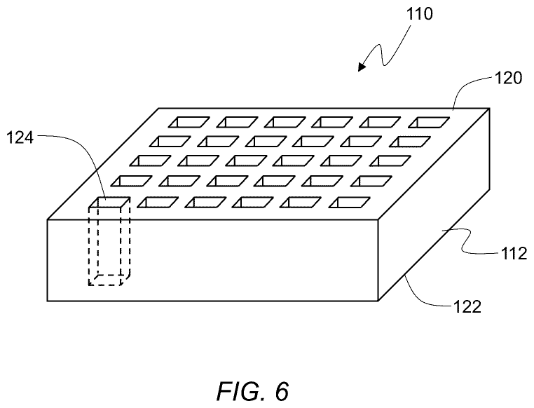

FIG. 6 is a perspective view of an exemplary structure in accordance with an embodiment of the present invention as applied to the cathode structure 110. The exemplary cathode structure 110 includes a buoyant component 112, which has a top surface 120 that may be exposed to atmosphere and a bottom surface 122 that submerges when the cathode structure 110 is placed in the aquatic environment 102. The buoyant component 112 may include a plurality of through-thickness holes 124 extending from the top surface 120 to the bottom surface 122 to increase the overall surface area with the waterline. While the holes 124 are shown to have a square cross section in the drawing, they may have other shapes and/or different shapes among them. Moreover, each hole should ideally be large enough to mitigate any surface tension effect. The shape of the buoyant component 112 depicted in FIG. 6 is not necessarily indicative of the optimum design, but does illustrate the method of increasing the surface to volume ratio. The buoyant component 112 may be made of a solid material that has a mass density lower than water, such as but not limited to low-density polyethylene. The buoyant component 112 may alternatively contain therein one or more cavities filled with low density substances or materials, such as but not limited to air and plastic foam, thereby reducing the overall density of the buoyant component 112 and allowing the cathode structure 110 to float in the aquatic environment 102.

The buoyant component 112 is coated with a first metal layer covering at least a portion of the buoyant component 112 that is submerged when the cathode structure 110 is placed in the aquatic environment 102, including the surface of the holes 124. The cathodic half reaction may occur on the first metal surface during operation. In an embodiment, the entire surface of the buoyant component 112 is covered with the first metal layer. The first metal layer may be made of copper (Cu) or a copper alloy, such as but not limited to aluminum bronze, bronze, and brass, and may be deposited onto the surface of the buoyant component 112 by electroless plating process. Copper and alloys thereof may also reduce or minimize biofouling on the surface of the cathode structure 110. The first metal layer may have a thickness ranging from tens of nanometers to several micrometers.

The cathode structure 110 may further include a second metal layer coated on the first metal layer. The second metal layer may be made of a noble metal or alloy that has a higher potential than the first metal layer, such as but not limited to gold (Au), palladium (Pd), platinum (Pt), palladium-cobalt alloy (PdCo), palladium-nickel alloy (PdNi), silver (Ag), and hard gold, and having a thickness ranging from tens of nanometers to several micrometers. Thinner second metal layers may be porous or contain pin holes, thereby exposing the first metal layer beneath, which comprises copper and thus may provide some anti-fouling benefit. The second metal layer may be deposited onto the first metal layer by electrolytic plating process. In embodiments where the cathode structure 110 is coated with the second metal layer, the cathodic reaction may take place on the surface of the second metal layer instead of the first metal layer.

The size of the cathode structure 110 may be limited owing to manufacturing limitations or cost. To increase the overall cathode surface, the galvanic system 100 may deploy an array of the cathode structures 110 with each of the cathode structures 110 electrically connected to the anode structure 104. The cathode structures 110 may be physically connected to each other at their periphery by fasteners made of copper, which would also provide electrical connection therebetween. Alternatively, the cathode structures 110 may be tethered to each other with or without direct electrical connection therebetween.

Referring back to FIG. 5, the anode structure 104 in its simplest form may consist of only the one or more pieces of iron or iron alloy directly attached to the one or more wires 114. Multiple pieces of iron or iron alloy may be linked together by fasteners made of a metal or alloy comprising copper. The iron or iron alloy would function as the anode material, while the first or second metal layer would function as the cathode material. The iron alloy may have an iron-rich composition. The iron alloy may have alloying components that are uniformly consumed by the anodic reaction, such as but not limited to iron-zinc alloy (FeZn).

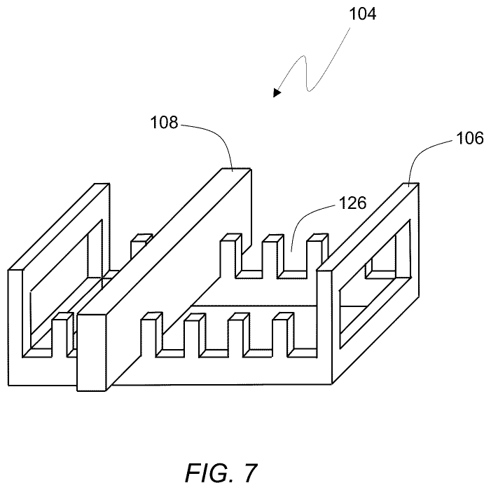

FIG. 7 is a perspective view of an exemplary structure in accordance with an embodiment of the present invention as applied to the anode structure 104. The anode structure 104 includes a rack holder 106 and one or more pieces of iron or iron alloy 108 separately seated in or fastened to the rack holder 106 made of a conductive material. The rack holder 106 has multiple slots 126 for holding multiple pieces of iron or iron alloy 108, which function as the anode material for iron dissolution. The iron alloy may have an iron-rich composition. The iron alloy may have alloying components that are uniformly consumed by the anodic reaction, such as but not limited to iron-zinc alloy (FeZn). The one or more lines or cables 118 and the one or more wires 114 may be attached to the rack holder 106 to suspend the rack holder 106 and the one or more pieces of iron or iron alloy 108 in the aquatic environment 102. Contacting the slots 126, the one or more pieces of iron or iron alloy 108 are electrically connected to the rack holder 106 and the one or more wires 114, which is electrically connected to the first metal layer of the cathode structure 110. The slots 126 also provide sufficient physical separation among multiple pieces of iron or iron alloy 108 to allow the local mass-transfer of the generated iron ions away from the anode surface, thereby keeping the iron ion concentrations in the thermodynamically stable region (i.e., without precipitation) for the local pH near the anode surface.

FIG. 7 shows one piece of iron or iron alloy 108 seated in a slot for illustration purpose. However, multiple pieces of iron or iron alloy 108 may be seated in the slots 126. Moreover, other designs of the rack holder (not shown) that allow multiple pieces of iron or iron alloy to be separately seated in different or mixed orientations may also be used in the present invention. The use of the rack holder 106 in the anode structure 104 may also facilitate the replenishment process for the anode material.

Proper choice of the material for the rack holder 106 may allow for either no dissolution of the holder material or a slight change in the corrosion potential with a very low rate of dissolution of the holder material that might help with anti-fouling. The rack holder 106 is made of a conductive metal whose nobility or potential may lie between that of the more noble first metal layer of the cathode structure 110 and the iron or iron alloy 108 and preferably has anti-fouling properties. For example and without limitation, the rack holder 106 may be made of a suitable alloy comprising copper, such as aluminum bronze.

As noted above, the stability of the iron ions is dependent upon the corrosion potential. Therefore, the one or more wires 114, which provide the electrical connection between the cathode and anode structures 110 and 104, should not engender a large voltage drop. As such, the wires 114 may be fabricated from a large gauge copper wire that is suitable to operate at up to 1 Amp of induced dissolution current and will not change the voltage by more than a few hundredths of volts for the first few hundred feet of length.

When operating the galvanic system 100 in the aquatic environment 102, the anode structure 104 may be suspended in a photic or aphotic zone at a certain depth to stimulate plankton growth. The separation of the floating cathode structure 110 and the submerged anode structure 104 during operation will likely prevent the pH rise near the cathode structure 110 from affecting the anodic reaction at the anode structure 104. If the desired photic zone is near the surface of the aquatic environment 102, then the separation between the structures 104 and 110 can be reduced to the point that the structures 104 and 110 physically touch each other, as long as the rise in pH near the cathode structure 110 during operation does not meaningfully affect the iron ion stability near anode surface of the anode structure 104.

While the present invention has been shown and described with reference to certain preferred embodiments, it is to be understood that those skilled in the art will no doubt devise certain alterations and modifications thereto which nevertheless include the true spirit and scope of the present invention. Thus the scope of the invention should be determined by the appended claims and their legal equivalents, rather than by examples given.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

What is claimed is:

1. A galvanic system for iron dissolution in an aquatic environment comprising:
an anode structure including one or more pieces of iron or iron alloy;
a cathode structure including a buoyant component and a first metal layer coated on the buoyant component, the first metal layer having a higher potential than the one or more pieces of iron or iron alloy; and
one or more wires electrically connect the first metal layer of the cathode structure to the one or more pieces of iron or iron alloy of the anode structure,
wherein the anode structure and at least a portion of the first metal layer are operably submerged in the aquatic environment.

2. The galvanic system of claim 1, wherein the aquatic environment is a body of saltwater.

3. The galvanic system of claim 1 further comprising one or more buoyant units that operably suspend the anode structure in the aquatic environment.

4. The galvanic system of claim 1, wherein the first metal layer comprises copper.

5. The galvanic system of claim 1, wherein an oxygen reduction reaction occurs on a surface of the cathode structure.

6. The galvanic system of claim 1, wherein the buoyant component has a lower density than a liquid in the aquatic environment.

7. The galvanic system of claim 1, wherein the buoyant component has one or more air pockets trapped therein.

8. The galvanic system of claim 1, wherein the buoyant component has a first surface operably exposed to atmosphere, a second surface operably submerged in the aquatic environment, and a plurality of holes extending from the first surface to the second surface.

9. The galvanic system of claim 8 further comprising a plurality of the cathode structures electrically connected to the one or more pieces of iron or iron alloy of the anode structure.

10. The galvanic system of claim 8 further comprising a plurality of the cathode structures that are physically connected to each other and to the cathode structure at periphery by fasteners made of copper.

11. The galvanic system of claim 1, wherein the cathode structure operably floats on a surface of the aquatic environment.

12. The galvanic system of claim 1 further comprising a second metal layer coated on the first metal layer, wherein the second metal layer has still another higher potential than the first metal layer.

13. The galvanic system of claim 12, wherein the second metal layer comprises any one of gold, palladium, platinum, or silver.

14. The galvanic system of claim 12, wherein the first and second metal layers each have a thickness ranging from tens of nanometers to several micrometers.

15. The galvanic system of claim 1, wherein the iron alloy comprises alloying components that are uniformly consumed by an anodic reaction.

16. The galvanic system of claim 1, wherein the iron alloy has an iron-rich composition.

17. The galvanic system of claim 1, wherein the anode structure further includes a rack holder having multiple slots for separately holding the one or more pieces of iron or iron alloy, the rack holder having a higher potential than the one or more pieces of iron or iron alloy.

18. The galvanic system of claim 17, wherein the rack holder is made of an alloy comprising copper.

19. The galvanic system of claim 17, wherein the rack holder is made of an alloy having a lower potential than the first metal layer.

20. The galvanic system of claim 17, wherein the one or more wires are attached to the rack holder.
